(19) United States
(12) Patent Application Publication
(10) Pub. No.: US 2010/0224558 A1
(43) Pub. Date: Sep. 9, 2010

(54) Water Filtration System

(76) Inventor: Jack Barker, Evergreen, CO (US)

Correspondence Address: Larson & Anderson, LLC, P.O. BOX 4928, DILLON, CO, 80435, US

(21) Appl. No.: 12/400,642

(22) Filed: Mar. 9, 2009

(51) Int. Cl. B01D 35/12; C02F 1/00; C02F 1/44; B01D 65/02

(52) U.S. Cl. 210/636; 210/791; 210/741; 210/333.01; 210/142; 210/321.69; 210/108

(57) ABSTRACT

A water filtration system includes a raw water line, a purified water line, and a plurality of water filtration units. The filtration units are connected in parallel between the raw water line and the purified water line. Each of the filtration units has a water filter disposed between and separating a raw water side of the unit connected to the raw water line and a purified water side of the unit connected to the purified water line. The raw water side of each unit has a drain opening. The system furthers includes a plurality of raw water valves each disposed between the raw water line and the raw water side of one of the plurality of units, a plurality of purified water valves each disposed between the purified water line and the purified water side of one of the plurality of units, and a plurality of drain valves each disposed to control flow through the drain opening of one of the plurality of units.

### BACKGROUND

Purified water is used in many industries including the chemical, foodstuffs, electronics, power, medical and pharmaceutical industries, as well as for human consumption. Typically, prior to use, the water is treated to reduce the level of contaminants to acceptable levels. These treatment techniques include chemical disinfection, distillation, filtration, ion exchange, photooxidation, ozonation, and combinations thereof. The present invention relates to water filtration.

Water filtration is used to remove suspended matter from a raw water supply but may also aid in the removal of dissolved (e.g. salts and metals) or colloidal species. Filters may be structured from a variety of materials including particulate matter such as sand, diatomaceous earth, or granular activated carbon (GAC), or may be based on a membrane that can be composed of a number of different materials including polymers and fibrous materials. Filters typically work by preventing the passage of suspended material while allowing water to pass through. One way of rating a filter is by its “pore size” which provides information as to what size particle will be restrained by the filter. Often times filters are able to be backwashed (e.g. they are backwashable) in order to “clean” the filter and remove trapped particles that build up and restrain the flow of water through the filter.

Municipal water purification plants as well as portable water purification systems make use of numerous water filtration units for purification. These plants and portable systems are able to provide a purified potable water stream from potentially contaminated water sources such as oceans, lakes, rivers, ponds, rainwater, and groundwater. The design of municipal plants and portable systems (e.g. the number and sizing of water filtration units) will depend upon numerous factors. These factors include among others the quality and quantity of water that is desired to be produced and the quality of the raw water supply. A system design engineer can calculate the size and number water filtration units that are required to meet the demands of the plant or portable water purification system.

In routine operation of the plants and portable systems periodic cleaning of the filtration units is required. This periodic cleaning often times includes backwashing the filtration unit where water is forced backward through the filter and out of the unit through a drain opening. This backwashing step may be coupled with a compressed gas scour of the filter inside the unit.

FIG. 1 shows a prior art water filtration system 101 that has a raw water line 103 and purified water line 105 and four water filtration units 107 connected in parallel between the raw water line 103 and the purified water line 105. Each of the water filtration units 107 are also connected to drain line 109. During operation of system 101 in water purification mode, raw water is provided in raw water line 103 and to each of the water filtration units 107. Purified water is provided from each of the water filtration units 107 into purified water line 105.

During a periodic cleaning routine of system 101, the system is brought out of purified water production mode and into backwash mode. While system 101 is operated in backwash mode, purified water head pressure in purified water line 105 is provided and purified water flows to the water filtration units 107 and backward through the water filter(s) of the associated unit 107. During backwash mode particles that have accumulated on or in the filter(s) of a unit 107 are removed from the filter and the unit and discarded through the drain line 109. Depending on the recommendations of the filter manufacture the backwash mode may be accompanied with a compressed gas (e.g. air) scour of the filter. If a compressed gas scour is employed, compressed gas is introduced from a compressed gas source 111 to each water filtration unit 107 and it exits with backwash water and particles through drain line 109.

In order to perform a backwash function on system 101 purified water head pressure must supplied via purified water line 105. This purified water may be supplied by a pump and a purified water backwash tank that stores purified water for the periodic backwash function. In another embodiment purified water head pressure and water is supplied from a portion of the purified water produced by a redundant water purification system(s) (e.g. a system that is identical or similar to system 101) operating in water purification mode while system 101 is in backwash mode. When system 101 has accomplished its backwash function it is placed back into water purification mode and its redundant system can then be placed in backwash mode. The backwash mode of the redundant system then is able to use a portion of the purified water produced by system 101 for its backwash mode (or water supplied by a pump and a purified water backwash tank as described above). This arrangement and sequence of switching between modes of system 101 and its redundant system can then be performed in perpetuity to provide a continuous purified water stream from the plant or portable system.

Several problems and points of inefficiency have been discovered with the above described system 101. First, it has been found that backwashing system 101 in the above described method has been found to not be able to clean the “dirtiest” filters satisfactorily. In other words, water like electricity follows the path of least resistance. In system 101, the backwash function cleans the “cleanest” filtration units (e.g. those with least filter resistance), and may not be able to clean the “dirtiest” filtration units (e.g. those with most filter resistance) satisfactorily or even at all. Second, in order to perform the backwash function a separate redundant system and/or a separate pump and backwash water tank are required to provide purified water and purified water head pressure for the backwash. Third, if the plant or portable system are desired to continuously produce purified water, then a separate redundant water purification system is required to be producing water while the first system is operated in backwash mode. This redundancy requirement adds to the number of pieces equipment required for proper operation and therefore the cost and size of a plant and a portable systems. Fourth, if an air scour is to accompany the backwash function, a compressed gas source sized to provide compressed air to all of the units 107 must also be provided. This also adds to the size and costs of municipal water plant and portable water systems.

It would be very desirable to provide smaller and cheaper municipal water treatment facilities and portable purified water systems. It would be even more desirable to incorporate minimal pieces of equipment while ensuring proper and thorough cleaning of each filtration unit.

### SUMMARY OF INVENTION

The present invention provides water filtration systems and a methods of use thereof, that address the above-mentioned needs. The presently provided water filtration system is for use in portable water purification applications and even in larger non-portable water applications such as municipal water purification plants.

In one embodiment the present invention provides a water filtration system comprising:
(I) a raw water line,
(II) a purified water line,
(III) a plurality of water filtration units, wherein:

the units are connected in parallel between the raw water line and the purified water line,

each of the units comprises a water filter disposed between and separating a raw water side of the unit connected to the raw water line and a purified water side of the unit connected to the purified water line,

the raw water side of each unit has a drain opening, and
(IV) a plurality of raw water valves each disposed between the raw water line and the raw water side of one of the plurality of units, a plurality of purified water valves each disposed between the purified water line and the purified water side of one of the plurality of units, and a plurality of drain valves each disposed to control flow through the drain opening of one of the plurality of units.

In another embodiment the present invention provides a method for continuously producing a purified water stream using the above water filtration system, wherein the method comprises the steps of:
(A) providing a raw water stream in the raw water line,
(B) removing a purified water stream from the purified water line, and
(C) performing a periodic backwash function on a selected unit or units while the remaining unit or units are producing purified water into the purified water line, wherein the backwash function comprises the steps of:

(i) closing the raw water valve and opening the drain valve associated with the selected unit or units,

(ii) allowing water from the purified water line to flow from the purified water line through the purified water valve, the filter, and then through the drain valve associated with the selected unit or units, and

(iii) closing the drain valve and opening the raw water valve associated with the selected unit or units, thereby continuously producing a purified water stream.

In a further embodiment, a water filtration unit is provided that comprises:

a raw water valve for connecting a raw water line to a raw water side of the unit,

a purified water valve for connecting a purified water line to a purified water side of the unit,

a drain valve for connecting a drain line with the raw water side of the unit,

a water filtration membrane disposed between and separating the raw water side from the purified water side of the unit,

a backwash tank containing purified water connected to the purified water side of the unit, and

a controller connected to the raw water valve, the drain valve, and the purified water valve, wherein the controller is programmed to perform a periodic backwash function on the unit wherein the periodic backwash function includes the steps of closing the raw water valve, leaving open the purified water valve, and opening the drain valve, and allowing purified water to pass from the purified water line and the backwash tank into the unit through the membrane filter and out of the unit through the drain line.

### BRIEF DESCRIPTION OF THE DRAWINGS

FIG. 1 shows a water filtration system of the past.

FIG. 2 shows a water filtration system in accordance with the present invention.

FIG. 3 shows a expanded view of a water filtration unit and its connections of FIG. 2.

FIG. 4 shows a water filtration system in accordance with the present invention.

FIG. 5 shows a water filtration unit adaptable for use with the present invention.

### DETAILED DESCRIPTION

The present invention may be understood more readily by reference to the following detailed description of preferred embodiments of the invention included herein. The present invention provides water filtration systems and a methods of use thereof, that address the above-mentioned needs. The water filtration system is for use in portable water purification applications and in larger non-portable water applications such as municipal water purification plants.

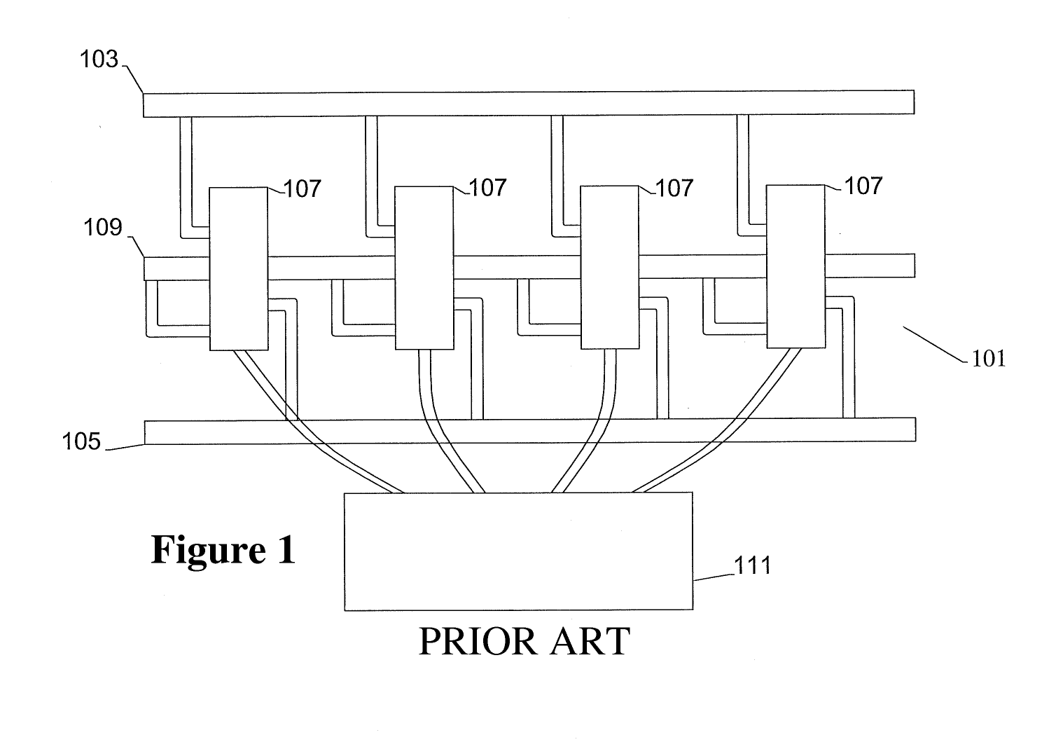

The present Inventor has found that a continuous purified water stream can be provided using the water filtration system of the present invention. The water filtration system of the present invention is an advancement over other water filtration systems of the past and in particular the one described in FIG. 1. In particular the present invention eliminates the need for a separate and redundant water purification system to provide purified water output and/or purified water head pressure for a backwash of the primary water system. The present invention provides a series of water purification units connected in parallel between a raw water line and a purified water line. Each of the units are individually capable of being isolated and individually backwashed apart from the remaining units that are producing purified water into the purified water line and thus generating purified water output and purified water head pressure to perform the individual unit backwash. Using this system allows for each unit to be given the full force of a individual backwash apart from other units. Furthermore, if an compressed gas scour is recommended by the manufacturer of the filtration unit, this can be accomplished using a much smaller compressed gas source that is sufficient for the scour of an individual unit rather than for all the filtration units at one time. The present Inventor believes that by using the systems and methods described herein, one can minimize the amount of equipment and maximize the efficiency of water filtration systems.

### Definitions:

As used in the specification and claims of this application, the following definitions should be applied.

“a”, “an”, and “the” as an antecedent refer to either the singular or plural. For example, “a water filtration unit” refers to either a single unit or a plurality of units unless the context indicates otherwise.

The term “between” as it is used to describe placement of pieces of equipment in the system is herein understood to mean that the referred to equipment is disposed along a flow path. For example a valve disposed “between” the raw water side of a water filtration unit and the raw water line is disposed along the flow path of water from the raw water line to the raw water side of referred to unit. “Between” does not necessarily mean, for example, that one can draw a straight line that connects the raw water line, the raw water valve, and the raw water side of a given unit.

Reference throughout the specification to “one embodiment,” “another embodiment,” “an embodiment,” “some embodiments,” and so forth, means that a particular element (e.g., feature, structure, property, and/or characteristic) described in connection with the embodiment is included in at least one embodiment described herein, and may or may not be present in other embodiments. In addition, it is to be understood that the described element(s) may be combined in any suitable manner in the various embodiments.

### A Water Filtration System:

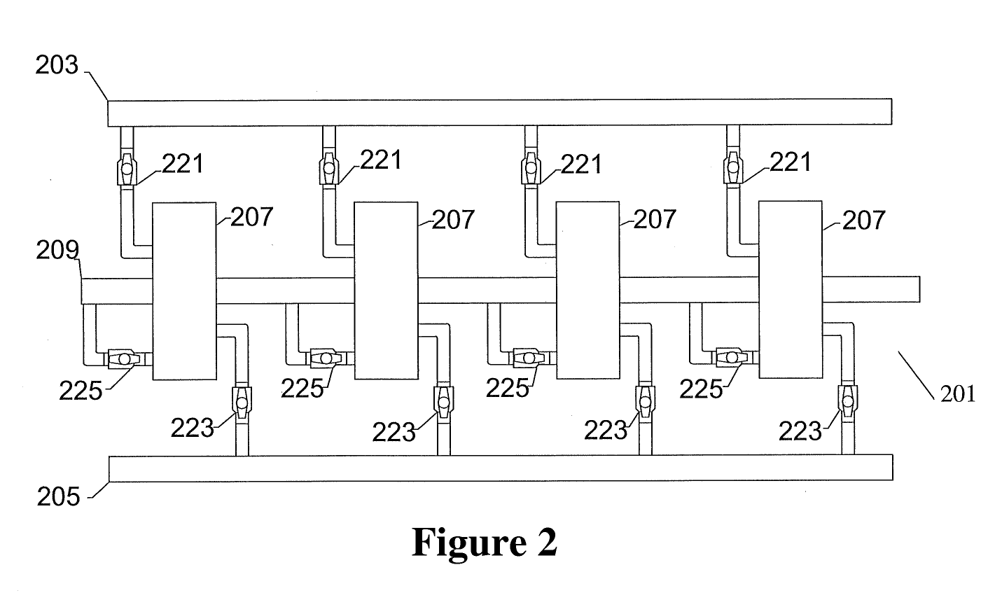

Turning to the water filtration system 201 shown in FIG. 2, system 201 comprises a raw water line 203, a purified water line 205, and a plurality of water filtration units 207. The plurality of water filtration units 207 are each connected in parallel between the raw water line 203 and the purified water line 205.

The water filtration system 201 may optionally further comprise one or more prefilters (not shown) disposed on the raw water line prior to water filtration units 207 (e.g. between a raw water source and the plurality of units 207). This prefilter(s) may be, for example, a course filter to remove larger particulate, bacteria, and/or viruses (herein after referred to as particulate). In one working embodiment, the prefilter is a conventional 20 micron filter although prefilters may range from relatively fine prefilters in the range of 5 to 20 microns to relatively course prefilters in the range of 50 to 100 microns, although prefilter size may filter anything from about 5 microns to about 100 microns. The prefilter(s) maybe isolated from the system 201 with isolation valves and a bypass line so as to be able to replace the prefilter for regular maintenance or prefilter blockage.

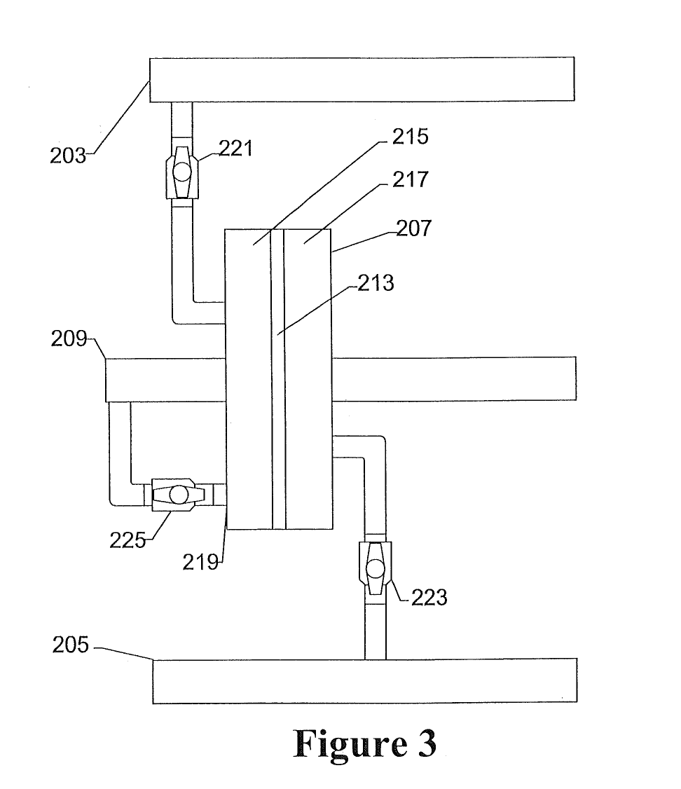

As shown in FIG. 3, which is an expanded view of one of the water filtration units and connections showing more detail not shown in FIG. 2, each of the units 207 comprises a water filter 213 disposed between and separating a raw water side 215 of the unit 207 connected to the raw water line 203 and a purified water side 217 of the unit 207 connected to the purified water line 205. The raw water side 215 of each unit 207 has a drain opening 219.

The water filtration system 201 also has a plurality of raw water valves 221 each disposed between the raw water line 203 and the raw water side 215 of one of the plurality of units 207, a plurality of purified water valves 223 each disposed between the purified water line 205 and the purified water side 217 of one of the plurality of units 207, and a plurality of drain valves 225 each disposed to control flow through the drain opening 219 of one of the plurality of units 207.

As shown in FIGS. 2 and 3 the drain valves 225 are preferably disposed between a common drain line 209 and the drain outlets 219 of the individual units 207. Common drain line 209 is preferred however it is not required as the raw water side 215 of each unit may drain through drain valve 225 into its own shared or individual line or simply onto the floor or ground.

The plurality of filtration units each comprise a water filter that is capable of being backwashed to remove particles that have adhered to the filter or have become trapped within the filter. The term “backwashed” or “backwash” and similar terms are used interchangeably herein and are understood to mean that the normal flow of water during routine operation of the unit is reversed so that water flows backward through the filter. In one embodiment, the water filtration units are available directly from manufacturers and are sometimes referred to in the art as water filtration cartridges or replaceable water filtration cartridges.

A list of non-limiting examples of filters that are suitable for use within the units of the present invention include charcoal filters, activated carbon filters, sand filters, membrane filters, and combinations thereof. For example each unit may have one or more of the filters described above, and/or each unit may have a different composition of filters. In a most preferred embodiment the water filtration units are membrane water filtration units that have a membrane or a plurality of membranes (e.g. up to several hundreds or several thousands of individual membranes, for example 100, 300, 500, 1,000, 2,000, 3,000, 4,000, or more individual membranes) separating the raw water side and purified water side of the unit. There are several sub-classifications of filters within the larger classification of “membrane” filters. In this regard distinctions are often made between this sub-classification based upon the material of construction of the membrane and its average pore size. Micro-membrane filters typically have a larger average pore size than Ultra-membrane filters which have larger average pore size than Nano-membrane filters which are larger still than Reverse-osmosis (RO) filters. Ultra-membrane filters or membrane filters having smaller pore sizes are often most preferred. These membrane filters are considered to be fine particulate filters and have average pore sizes of at least about 0.001 microns. In a preferred embodiment the average pore size of the membrane filter will be less than 5.0 microns (e.g. between 0.001 microns to 4.0 microns), and more preferably in a range of between 0.01 and 2.9 microns.

There are several manufacturers of membrane water filters and water filtration units (e.g. membrane filtration cartridges) that are suitable for use with the present invention. For example General Electric Water & Process Technologies manufacturers Zenon Membrane filters which are used in the GE® HOMESPRING™ water filtration unit. Zenon Membrane filters are suitable for use with the present invention and are sized (e.g. about 0.02 micron membrane pore size) to eliminate bacterial and viral agents.

Each of the plurality of raw water valves 221, the plurality of purified water values 223, and the plurality of drain valves 225, may be manually operable by a human operator to perform the backwash function manually and/or mechanically operable via a control loop for example wherein the valves are solenoid activated valves and are connected to a controller pneumatically, hydraulically, electronically, or combinations thereof. In a preferred embodiment, the controller is a programmable logic controller (PLC).

Where a controller (e.g. a PLC), the water filtration system further comprises a controller connected to each of the plurality of raw water valves, the plurality of purified water values, and the plurality of drain valves. The controller can be programmed to perform a backwash function on a selected unit or units while the remaining unit or units continue to produce purified water into the purified water line, thereby delivering purified water and pressure to each individual unit for the backwash. The periodic backwash function comprises the steps of:

(i) closing the raw water valve and opening the drain valve associated with the selected unit or units,

(ii) allowing water from the purified water line to flow through the purified water valve, through the filter, and then through the drain valve associated with the selected unit or units, and

(iii) closing the drain valve and opening the raw water valve associated with the selected unit or units. In this later embodiment, the periodic backwash function may preferably further comprise the steps performed after step (ii) and prior to step (iii) of:
closing the purified water valve associated with the selected unit or units,
allowing the raw water side associated with the selected unit or units to drain,
opening the raw water valve associated with the unit or units,
closing the raw water valve associated with the unit or units, and
allowing the raw water side associated with the selected unit or units to drain.

The controller preferably will preferably comprise an operator interface device for receiving manual input from an operator to program the controller and/or to manually select a unit or units to perform the backwash function on (e.g. a button or buttons). In another embodiment, the controller is programmable and/or preprogrammed to select a unit or units to perform the backwash function on. For example the controller may be programmed to perform the backwash function on a single unit or all of the units in the system in a cycle starting at a predetermined time (e.g. in response to a triggered condition or exceeded threshold, at predetermined time interval, a predetermined time of day, and combinations thereof).

In one embodiment, each unit further comprises a pressure transducer in fluid contact with the raw water side and a pressure transducer in fluid contact with the purified water side. Each transducer is connected to the controller wherein the controller is programmed to calculate a pressure difference between the raw water side and the purified water side of each unit and to select the unit or units to perform the backwash function on if the calculated pressure difference exceeds a predetermined threshold. In this regard the controller may comprise a differential pressure switch connected to the pressure transducers on each side of the membrane to calculate the differential pressure and provide information to the controller about which unit to perform the backwash function on. Again if a pressure differential threshold is exceeded in a unit the controller may be programmed to automatically backwash all units in the system in a cycle or predetermined array.

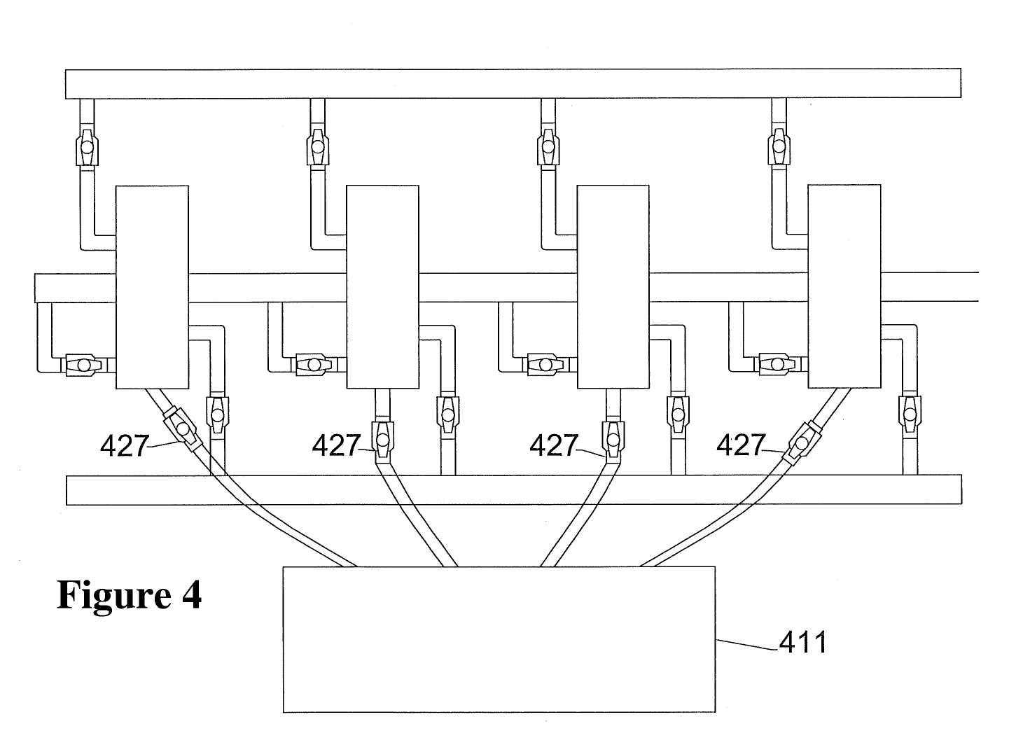

Depending upon the recommendations from the manufacture, each and/or all of the individual units and the filters contained therein may be scoured (e.g. scrubbed) before, during, or after the backwash function with compressed gas (e.g. compressed ambient air or some other gas such as nitrogen CO₂). It is believed that gas scouring can help to further agitate the filters so as to remove more particles disposed in and on the filter. As shown in FIG. 4 (which has been redacted from FIG. 2 to omit callout numbers to non-referenced equipment) the water filtration system 401 further comprises a plurality of compressed gas valves 427 each disposed between a compressed gas source 411 (e.g. an air compressor and/or a compressed air tank) and the raw water side of one of the plurality of units. The compressed gas introduction to the raw water side of the unit may be, for example, through the drain outlet of the unit, or it may be through a separate inlet of the unit.

As with the raw water valves, the purified water valves, and the drain valves the compressed gas valves can be manually operable, mechanically operable in response to stimulus from a control device, or a combination thereof. In a preferred embodiment, each of the compressed gas valves are connected to the controller described above wherein the programmed periodic backwash function further comprises the steps occurring between steps (i) and (iii) of opening the compressed gas valve and allowing compressed gas to flow from the compressed gas source through the compressed gas valve, into the raw water side, and then out through the drain valve associated with the selected unit or units.

In a further embodiment, the system may further comprise a purified water backwash tank that contains purified water to aid in the backwash function of the individual units. In this embodiment the backwash tank could be connected to the purified water line (205 in FIG. 2) to provide supplemental water and pressure for a backwash procedure.

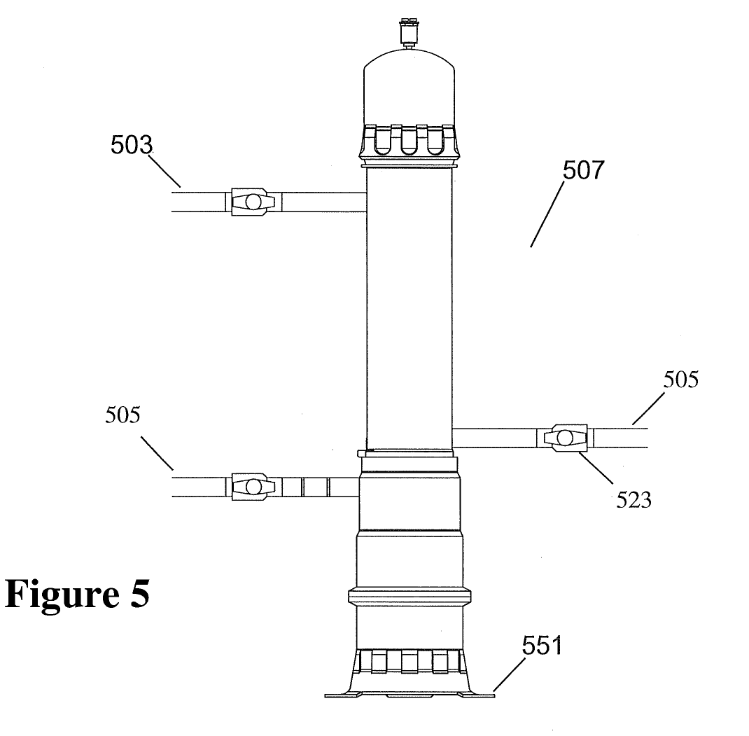

Applicants note that prior art water purification units could be adapted to be suitable for use with systems of the present invention. As shown in FIG. 5, Applicant notes that the GE® HOMESPRING™ water filtration unit 507 comprises a purified water backwash tank 551 in its water filtration unit 507. During water purification operation water flows from raw water line 503 through unit 507 and exits in purified water line 505. During the backwash function of the unit 507, only water from the purified backwash tank 551 is used for the backwash. To accomplish this task unit 507 comprises a check valve 523 that prevents water from flowing from purified water line 505 backward through unit 507. During backwash of unit 507 water from backwash tank 511 flows backward through the unit 507 and its filter and out of drain 509. If this check valve 523 were removed and/or replaced with a purified water valve, in accordance with the description above, that allows water from purified water line 505 to flow backward through and backwash unit 507, then this unit could be suitable for use with the systems and methods of the present invention. In this embodiment, purified water from both the backwash tank 551 and the purified water line 505 can be used to backwash unit 507 and exit as a combined drain line 509.

In accordance with this embodiment, a water filtration unit is provided that comprises:

a raw water valve for connecting a raw water line to a raw water side of the unit,

a purified water valve for connecting a purified water line to a purified water side of the unit,

a drain valve for connecting a drain line with the raw water side of the unit,

a water filtration membrane disposed between and separating the raw water side from the purified water side of the unit,

a backwash tank containing purified water connected to the purified water side of the unit, and

a controller connected to the raw water valve, the drain valve, and the purified water valve, wherein the controller is programmed to perform a periodic backwash function on the unit wherein the periodic backwash function includes the steps of closing the raw water valve, leaving open the purified water valve, and opening the drain valve, and allowing purified water to pass from the purified water line and the backwash tank into the unit through the membrane filter and out of the unit through the drain line.

In another embodiment, this water filtration unit further comprises a pressure transducer in fluid contact with the raw water side and a pressure transducer in fluid contact with the purified water side. Each transducer is connected to the controller wherein the controller is programmed to calculate a pressure difference between the raw water side and the purified water side of the unit and to perform a backwash function on the unit if the calculated pressure difference exceeds a predetermined threshold. A differential pressure switch may be employed as explained above.

### A Method of Using the Water Filtration System:

The present invention also provides a method for continuously producing a purified water stream using the water filtration system described in any of the embodiments above. The method comprises the steps of:
(A) providing a raw water stream in the raw water line,
(B) removing a purified water stream from the purified water line, and
(C) performing a periodic backwash function on a selected unit or units while the remaining unit or units are producing purified water into the purified water line. The backwash function comprises the steps of:

(i) closing the raw water valve and opening the drain valve associated with the selected unit or units,

(ii) allowing water from the purified water line to flow from the purified water line through the purified water valve, the filter, and then through the drain valve associated with the selected unit or units, and

(iii) closing the drain valve and opening the raw water valve associated with the selected unit or units, thereby continuously producing a purified water stream.

In another embodiment, the periodic backwash function of step (C) further comprises the steps performed after step (ii) and prior to step (iii) of:
closing the purified water valve associated with the selected unit or units,
allowing the raw water side associated with the selected unit or units to drain,
opening the raw water valve associated with the unit or units,
closing the raw water valve associated with the unit or units, and
allowing the raw water side associated with the selected unit or units to drain.

Step C may be performed manually by an operator or by a controller connected to each of the plurality of raw water valves, the plurality of purified water values, and the plurality of drain valves, wherein the controller is programmed to perform the periodic backwash function of step (C) on the unit or units in a cycle as described above. In this later embodiment it is most preferred that each of the valves are solenoid activated valves and are connected to the controller pneumatically, hydraulically, electronically, or combinations thereof.

Where a compressed gas scour of the unit(s) is recommended by the manufacture, the periodic backwash function further comprises the steps occurring between steps (i) and (iii) of opening the compressed gas valve and allowing compressed gas to flow from the compressed gas source through the compressed gas valve, into the raw water side, and then out through the drain valve associated with the selected unit or units.

### Materials of Water Filtration System Construction:

The materials of construction of the water filtration systems of the present invention are not particularly limited. Where the water filtration systems are designed to be portable, the system designer may design the water filtration system to be self contained (e.g. with a raw water hook up port, a purified water hookup port, a drain line hookup port, and an electrical hookup port if necessary) and sized to be easily moved, for example by a forklift. In this regard, the designer may contemplate that a filtration system comprising four to 6 water filtration units could be installed on a base metal (e.g. diamond plate aluminum) skid plate, wherein the total measurements of the filtration system measures less than four feet deep, five feet high, and eight feet long (e.g. less than 3 feet deep, 4 feet high, and seven feet long). Furthermore, in portable applications it is desired that the lines (e.g. the raw water line, the purified water line, and drain line if applicable) are made of a light weight material like a polymeric material such as a rigid polyvinylchloride or flexible polyester material.

Where weight and portability are not an issue, for example where the system is to be installed in more permanent type of application (e.g. a municipal water plant), other materials of construction are suitable. For example, concrete and metal piping, may be the preferred materials of constructions.

### Additional Embodiments

As described in U.S. patent application Ser. No. 12/032,914 filed on Feb. 18, 2008, which is incorporated herein by reference for all purposes, a water purification unit may be powered via a battery connected to a non-grid power source such as photovoltaic array, a generator, a diesel fuel cell, a methanol fuel cell, a hydrogen fuel cell, a wind turbine generator, or a vehicle power connection. In remote locations photovoltaic arrays are often preferred. In one embodiment of the present invention wherein the water filtration system comprises a controller programmed to perform the backwash functions, the water filtration system further comprises power unit to provide “non-grid” electrical energy to the water filtration system. The power unit is sufficient to provide electrical energy for the operation of the controller, the plurality of raw water valves, the plurality of purified water valves, and the plurality of drain valves. If an air scour is recommended, the power unit is also sufficient to provide electrical energy to a gas compressor and the plurality of compressed gas valves.

The power unit comprises a battery electrically coupled to water filtration system and a non-grid power source electrically coupled to the battery as described in the Ser. No. 12/032,914 application. In this embodiment, head pressure in the raw water line provides flow through the water filtration units and purified water flow in the purified water line. The flow in the purified water line is sufficient to provide a continuous stream of purified water and the necessary backwash flow and pressure should a unit be selected for a backwash function.

Head pressure in the raw water line can be developed by a raw water supply pump or it can be present in a raw water line obtained from an elevated raw water source or a municipal facility. The Ser. No. 12/032,914 application describes the incorporation of a raw water pump in the purification unit that is powered by the power unit (battery and the non-grid energy source) to provide head pressure in the raw water line that is suitable for the flow requirements of the unit. In the present invention it is contemplated that the water purification system further comprises a raw water pump disposed between a raw water source and the raw water line as described. In the present embodiment, the raw water pump is also powered by the power unit.

1. A method for continuously producing a purified water stream using a water filtration system, wherein the water filtration system comprises:
(I) a raw water line,
(II) a purified water line,
(III) a plurality of water filtration units, wherein:
the units are connected in parallel between the raw water line and the purified water line,
each of the units comprises a water filter disposed between and separating a raw water side of the unit connected to the raw water line and a purified water side of the unit connected to the purified water line,
the raw water side of each unit has a drain opening, and
(IV) a plurality of raw water valves each disposed between the raw water line and the raw water side of one of the plurality of units, a plurality of purified water valves each disposed between the purified water line and the purified water side of one of the plurality of units, and a plurality of drain valves each disposed to control flow through the drain opening of one of the plurality of units, and the method comprising the steps of:
(A) providing a raw water stream in the raw water line,
(B) removing a purified water stream from the purified water line, and
(C) performing a periodic backwash function on a selected unit or units while the remaining unit or units are producing purified water into the purified water line, wherein the backwash function comprises the steps of:
(i) closing the raw water valve and opening the drain valve associated with the selected unit or units,
(ii) allowing water from the purified water line to flow from the purified water line through the purified water valve, the filter, and then through the drain valve associated with the selected unit or units, and
(iii) closing the drain valve and opening the raw water valve associated with the selected unit or units, thereby continuously producing a purified water stream.

2. The method of claim 2, wherein the water filtration system further comprises:
(V) a controller connected to each of the plurality of raw water valves, the plurality of purified water values, and the plurality of drain valves, wherein the controller is programmed to perform the periodic backwash function of step (C).

3. The method of claim 2, wherein the water filtration system further comprises:
a plurality of compressed gas valves each disposed between a compressed gas source and the raw water side of one of the plurality of units, and each of the compressed gas valves connected to the controller, wherein the periodic backwash function further comprises the steps occurring between steps (i) and (iii) of opening the compressed gas valve and allowing compressed gas to flow from the compressed gas source through the compressed gas valve, into the raw water side, and then out through the drain valve associated with the selected unit or units.

4. The method of claim 2, wherein the periodic backwash function of step (C) further comprises the steps performed after step (ii) and prior to step (iii) of:
closing the purified water valve associated with the selected unit or units,
allowing the raw water side associated with the selected unit or units to drain,
opening the raw water valve associated with the unit or units,
closing the raw water valve associated with the unit or units, and
allowing the raw water side associated with the selected unit or units to drain.

5. The method of claim 2, wherein the controller comprises an operator interface device for receiving manual input from an operator to select a unit or units to perform the backwash function on.

6. The method of claim 2, wherein the controller is programmed to select a unit or units to perform the backwash function on.

7. The method of claim 6, wherein each unit further comprises a pressure transducer in contact with the raw water side and a pressure transducer in contact with the purified water side, each transducer is connected to the controller wherein the controller is programmed to calculate a pressure difference between the raw water side and the purified water side of each unit and to select the unit or units to perform the backwash function on in response to a determination that the calculated pressure difference exceeds a predetermined threshold.

8. The method of claim 7, wherein the controller is programmed to perform the backwash function on all of the units in the system in a cycle starting in response to the determination that the calculated pressure difference exceeds the predetermined threshold.

9. The method of claim 2, wherein the system further comprises a power unit to provide electrical energy to the system, wherein the power unit comprises a battery electrically coupled to the system, and a non-grid power source electrically coupled to the battery.

10. The method of claim 1, wherein each of the plurality of raw water valves, the plurality of purified water values, and the plurality of drain valves, are manually operable, and wherein the periodic backwash function of step (C) is performed manually.

11. The method of claim 1, wherein each of the plurality of water filtration units are membrane water filtration units comprising a membrane filter.

12. A water filtration system comprising:
(I) a raw water line,
(II) a purified water line,
(III) a plurality of water filtration units, wherein:
the units are connected in parallel between the raw water line and the purified water line,
each of the units comprises a water filter disposed between and separating a raw water side of the unit connected to the raw water line and a purified water side of the unit connected to the purified water line,
the raw water side of each unit has a drain opening, and
(IV) a plurality of raw water valves each disposed between the raw water line and the raw water side of one of the plurality of units, a plurality of purified water valves each disposed between the purified water line and the purified water side of one of the plurality of units, and a plurality of drain valves each disposed to control flow through the drain opening of one of the plurality of units.

13. The water filtration system of claim 12, further comprising:
(V) a controller connected to each of the plurality of raw water valves, the plurality of purified water values, and the plurality of drain valves, the controller is programmed to perform a backwash function on a selected unit or units while the remaining unit or units continue to produce purified water into the purified water line, wherein the periodic backwash function comprises the steps of:
(i) closing the raw water valve and opening the drain valve associated with the selected unit or units,
(ii) allowing water from the purified water line to flow through the purified water valve, through the filter, and then through the drain valve associated with the selected unit or units, and
(iii) closing the drain valve and opening the raw water valve associated with the selected unit or units.

14. The water filtration system of claim 13, further comprising a plurality of compressed gas valves each disposed between a compressed gas source and the raw water side of one of the plurality of units, and each of the compressed gas valves connected to the controller, wherein the periodic backwash function further comprises the steps occurring between steps (i) and (iii) of opening the compressed gas valve and allowing compressed gas to flow from the compressed gas source through the compressed gas valve, into the raw water side, and then out through the drain valve associated with the selected unit or units.

15. The water filtration system of claim 13, wherein the periodic backwash function further comprises the steps performed after step (ii) and prior to step (iii) of:
closing the purified water valve associated with the selected unit or units,
allowing the raw water side associated with the selected unit or units to drain,
opening the raw water valve associated with the unit or units,
closing the raw water valve associated with the unit or units, and
allowing the raw water side associated with the selected unit or units to drain.

16. The water filtration system of claim 13, wherein each of the plurality of raw water valves, the plurality of purified water values, and the plurality of drain valves, are solenoid activated valves and are connected to the controller pneumatically, hydraulically, electronically, or combinations thereof.

17. The water filtration system of claim 13, wherein the controller comprises an operator interface device for receiving manual input from an operator to select a unit or units to perform the backwash function on.

18. The water filtration system of claim 13, wherein the controller is programmed to select a unit or units to perform the backwash function on.

19. The water filtration system of claim 18, wherein each unit further comprises a pressure transducer in contact with the raw water side and a pressure transducer in contact with the purified water side, each transducer connected to the controller wherein the controller is programmed to calculate a pressure difference between the raw water side and the purified water side of each unit and to select the unit or units to perform the backwash function on if the calculated pressure difference exceeds a predetermined threshold.

20. The water filtration system of claim 19, wherein the controller is programmed to perform the backwash function on all of the units in the system in a cycle starting in response to the determination that the calculated pressure difference exceeds the predetermined threshold.

21. The water filtration system of claim 13, wherein the system further comprises a power unit to provide electrical energy to the system, wherein the power unit comprises a battery electrically coupled to the system, and a non-grid power source electrically coupled to the battery.

22. The water filtration system of claim 12, wherein each of the plurality of raw water valves, the plurality of purified water values, and the plurality of drain valves, are manually operable.

23. The water filtration system of claim 12, wherein each of the plurality of water filtration units is membrane water filtration unit comprising a membrane filter.

24. A water filtration unit comprising:
a raw water valve for connecting a raw water line to a raw water side of the unit,
a purified water valve for connecting a purified water line to a purified water side of the unit,
a drain valve for connecting a drain line with the raw water side of the unit,
a water filtration membrane disposed between and separating the raw water side from the purified water side of the unit,
a backwash tank containing purified water connected to the purified water side of the unit, and
a controller connected to the raw water valve, the drain valve, and the purified water valve, wherein the controller is programmed to perform a periodic backwash function on the unit wherein the periodic backwash function includes the steps of closing the raw water valve, leaving open the purified water valve, and opening the drain valve, and allowing purified water to pass from the purified water line and the backwash tank into the unit through the membrane filter and out of the unit through the drain line.

25. The water filtration unit of claim 24, further comprising a pressure transducer in contact with the raw water side and a pressure transducer in contact with the purified water side, each transducer is connected to the controller wherein the controller is programmed to calculate a pressure difference between the raw water side and the purified water side of the unit and to perform the backwash function in response to a determination that the calculated pressure difference exceeds a predetermined threshold.
